(19) United States
(12) Patent Application Publication
(10) Pub. No.: US 2010/0332554 A1
(43) Pub. Date: Dec. 30, 2010

(54) Method of Analyzing Ephedrine Purchase Logs

(76) Inventors: Mark C. Blair, Erie, PA (US); Derek D. Mulder, Erie, PA (US); Brian M. Camodeca, Ashtabula, OH (US)

Correspondence Address: Joseph F. Gula, III, 120 West Tenth Street, Erie, PA, 16501, US

(21) Appl. No.: 12/824,189

(22) Filed: Jun. 27, 2010

Related U.S. Application Data
(60) Provisional application No. 61/221,849, filed on Jun. 30, 2009.

(51) Int. Cl. G06F 17/30

(52) U.S. Cl. 707/802; 707/E17.005

(57) ABSTRACT

Law enforcement personnel have found illegal purchases of ephedrine-containing products are difficult to control due to limitations in analyzing the available data. The within invention breaks through these limitations and addresses multi-purchaser activity over a set geographic area. This allows law enforcement to stay ahead of illicit ephedrine purchasers while ignoring normal, legal purchases of these over-the-counter cold remedies.

The method described herein is an analytic program that automates ephedrine purchase log analysis based on law enforcement experience and intelligence analysis experience. Without human assistance, the invention, a web-viewed service delivered either over local area networks or the interne, pinpoints and extracts the most suspicious names from the data logs for further investigation by the local police department. The automated invention instantaneously delivers a list of likely illegal ephedrine purchasers, sorted by level of suspicion to assist law enforcement.

### CROSS REFERENCE TO RELATED APPLICATIONS

The present application claims the benefit of U.S. Provisional Application No. 61,221,849 filed on Jun. 30, 2009, which is incorporated herein by reference.

### FEDERALLY SPONSORED RESEARCH

Not Applicable

### BRIEF DESCRIPTION OF THE DRAWINGS

FIG. 1 is a graph illustrating the change in suspicion levels depending upon the number of purchaser pairs with co-buys.

FIG. 2 is a screenshot from the within system relating to purchasers of ephedrine-based products.

FIG. 3 is a screenshot from the within system illustrating the Report Detail generated by the system.

FIG. 4 is a screenshot of an example purchase report generated by the within system when a purchaser exceeds the program parameters.

FIG. 5 is a flowchart representation of the graphical user interface for the within system.

FIG. 6 is a flowchart representation of the software analysis for the within system.

FIG. 7 is a graph illustrating red flags assigned to purchases in the within system.

FIG. 8 is a graph illustrating temporal purchase proximity to other purchasers in the within system.

### DESCRIPTION

Methamphetamine is one of the most addictive illicit drugs an illegal drug abuser can use. In order to make their illicit drug, modern methamphetamine laboratories have a common needed drug. That needed drug is ephedrine. Congress passed the Combat Methamphetamine Epidemic Act (CMEA) in an attempt to combat this plague on our society. The CMEA limits the amount of ephedrine (and related compounds such as pseudephedrine) an individual can purchase over-the-counter. An individual who wants to purchase ephedrine-containing products must do so at the pharmacy counter and also provide a valid state-issued identification card for verification purposes. Thus, individual pharmacies keep a log of sales of ephedrine purchases. Pharmacies send in their ephedrine purchaser logs to local law enforcement for review.

The goal of the CMEA was to choke off the methamphetamine manufacturer's (also known as meth cooks') ephedrine supply. The meth cooks have adapted to this new ephedrine log requirement by coordinating their efforts. Law enforcement personnel have found that many meth cooks have organized into tightly coordinated rings of ephedrine pill shoppers, with controllers monitoring membership, as well as purchase quantities, qualities, times and locations. These actions have exploited police departments' limitations in analyzing the available data. The within invention breaks through these limitations and addresses multi-purchaser activity over a set geographic area. This allows law enforcement to stay ahead of illicit ephedrine purchasers while ignoring normal, legal purchases of these over-the-counter cold remedies.

The method described herein is an analytic program that automates ephedrine purchase log analysis based on law enforcement experience and intelligence analysis experience. Without human analysis, the invention pinpoints and extracts the most suspicious names from the data logs for further investigation by the local police department. The invention instantaneously delivers a list of likely illegal ephedrine purchasers, sorted by level of suspicion to assist law enforcement.

The method described herein is a system which is a web-viewed service referred to hereinafter as “Meth Hunter” that is delivered to a computer either over local area networks or the internet. The entire system can be hosted on a single computer, if necessary. The system is viewed by a computer's web-browsers capable of using the javascript XML Request functionality (AJAX). The system is served over a web-server such as Internet Information Services (IIS) or Apache and requires an SQL-based database to host the data. The system is designed to run on a web-service languages such as PHP, ASP, Coldfusion or Perl. The system can run on any computer's operating system capable of supporting the web-services, the SQL database and the web-service language, for example Microsoft Windows XP/Vista/7, Unix-like operation systems and Mac OS X.

The ability to run the Meth Hunter both on local area networks and as an internet service is central to the Meth Hunter's ability to conform to informational security protocols. The installation of the Meth Hunter on a local area network ensures that all information handling is done locally on law enforcement systems, without compromising data or security concerns.

The system is comprised of a MySQL database overlaid by PHP interface scripts (or other web-service languages). The PHP script utilizes a series of SQL queries that filter and aggregate data into arrays for display to the human analyst. The PHP script will also query web-based mapping application programming interfaces (APIs) to calculate distances and travel-time calculations for pseudoephedrine purchases. Data points link dynamically through geographic characteristics, temporal relationships, pseudoephedrine purchase type and quantity. The user interface design and structure is a display with multiple tabs:

Purchaser Tab: lists all purchasers (name and state identification number, the number of purchases they have made, the total amount in grams of pseudoephedrine they have purchased, and the number of Red Flags indicating their suspicion level.

Report Detail Tab: lists groups of reports and relationships between purchases that are responsible for the level of suspicion associated with each purchaser of interest:
A summary of the individual (same as viewed under Purchaser Tab)
Possible aliases, alternative addresses, relationships to other purchasers
Purchases made by the selected purchaser in suspicious frequency to one another
Purchases made by the selected purchaser within a suspicious time proximity to purchases made by other purchasers.
All purchases made by the selected purchaser

All Purchases Tab: displays all purchases within the database. With the Search and Sort By tools the user can easily organize and narrow the purchase record by user specified criteria.

Pill Shopping Cells Tab: displays groups of individuals demonstrating suspicious behaviors that are related through purchasing patterns and purchased pseudoephedrine-based product type. Individuals who manufacture illicit methamphetamine (the “cooks”) generally synthesize methamphetamine in cycles and show favoritism toward a specific pseudoephedrine-source product. Pill shoppers associated with a particular cook can be identified through the temporal proximity of their purchases and type of product they purchase. Pill Shopping Cells generally exclude purchasers with a low suspicion value (low number of Red Flags).

Import Data Tab: displays a number pharmacies and ephedrine reporting log companies. The user simply clicks on the button with the name of the pharmacy they wish to upload information from (i.e. Walgreens, Walmart, MethCheck, TMIS, etc) and a navigation window will pop up in which they can navigate to the file containing the data they wish to upload. The within invention then parses the data into its SQL Database.

### Data

Pseudoephedrine purchase tracking systems record and report information about the individual purchases of products containing pseudoephedrine/ephedrine. Each report of a purchase is referred to as a data point. Data points are made up of components, such as first and last name, purchase location, etc. The data components collected and presented in the data sheets provided by a pseudoephedrine tracking system (such as MethCheck) are referred to as “Organic Data Components.” Data components that are added to each data point by the Meth Hunter through the calculation of data are referred to as “Calculated Data Components.” Data components that are used to identify the relationships between other data components are referred to as “Relational Data Components.” Data components used in calculations and relational analysis (link analysis) are often assigned a numeric identifier referred to as a “unique id.” A unique id may be used to represent a single data component (i.e. location id) or a relationship between to data components (i.e. name-to-name id).

### Organic Data Point Components:

Name (first and last)

Address or Purchaser (number, street, city, state, zip code, and geo-coordinates)

Date of Purchase

Time of Purchase

Description of Purchase (brand name, product type, etc)

Quantity of Pseudoephedrine in Product (in grams)

### Calculated Data Components:

Number of purchases in a specified time period

Total quantity of pseudoephedrine purchased in a specified time period

Distance from purchaser's home to point of sale

Time between purchases of a single purchaser

Time between the purchases of different multiple purchasers

### Relational Data Components:

Time interval data:
Time between the purchases of a single purchaser
Time between the purchases of one purchaser and another
Time between the purchases of different multiple purchasers
Time-travel-distance relationship between purchases at different pharmacies

Purchase Information Data Point links:
Driver's license number associated to multiple names/address
Family/last name associated to multiple first names (family relation)
Address associated to multiple driver's license numbers/names (purchasers)
Product information links
Product description associated with multiple suspicious purchasers
Quantity (in grams) of pseudoephedrine in product associated with multiple suspicious purchases

### Data Filtration:

Individual data points are analyzed for suspicious characteristics and relationships. Data points determined to have suspicious characteristics are flagged and weighted to identify suspicion levels of other data points that are related to them. The filtration process searches for 5 characteristics:
Identified Individuals of Interest
Identified Addresses of Interest
Large distance between home and point of sale
Type of product or purchase
Amount of pseudoephedrine in purchase (not suspicious<1.0 g, 1.44-2.44 g=most suspicious, 2.44-3.6 g=suspicious).

Multiple data points are aggregated to determine if they have a suspicious relationship within the larger body of data. The filtration process must identify 8 relationships:
Number of purchases in a specific time period
Same individual purchasing from multiple locations
Same individual making multiple purchases in a day
Purchasing pattern (weekly, biweekly, etc.)
Favoritism toward a single product (a twelve-hour release product vs. a twenty-four hour release product, identical product purchased repeatedly, etc.)
Time between purchases (within suspicious time period: i.e.: 10 minutes, 30 minutes, 60 minutes, etc.)
Historic shopping pattern
Relation to other purchasers (multiple purchases within a suspicious temporal proximity to other shoppers)

### Report Production:

The within invention automatically generates a PDF report of potential pill shoppers formatted to facilitate the arrest/search warrant process which includes the following information. Paragraphs and data are only included when they are applicable to the individual in question:
Name.
Aliases.
Driver license number.
Date range of all purchases in consideration.
Number of purchases.
Total amount of pseudoephedrine purchased (in grams).
Paragraph explaining purchase restriction under the Combating Methamphetamine Epidemic Act (CMEA), and the purchase records when the individual exceeded those limits.
Table of purchases made within a suspicious time period (preceded by a paragraph explaining the general purchasing behaviors of “pill shoppers”)
A paragraph explaining the favored amount of pseudoephedrine in products; the amount of pseudoephedrine in the pill shopper's typical purchase; and the number of time that product was purchased.
A paragraph identifying the number of purchases of the same brand/type of pseudoephedrine-based products and following paragraph explaining the tendency for meth cooks to favor one particular brand/type and direct pill shoppers to purchase it.
A paragraph identifying times that the pill shopper purchased pseudoephedrine in a close temporal-proximity to other persons buying pseudoephedrine-based products and the locations of the purchases and an explanation of how pill shoppers shop in groups of 2 or more to increase the yield of pseudoephedrine purchase at a single time or location.
A table listing all purchases by the subject (pill shopper) of the report.
A table of all purchases made within a close temporal proximity to another purchaser/pill shopper.

### Indication/Suspicion Representation:

Some behaviors and ephedrine purchases are more suspicious than others. The within invention incorporates a systematic way of representing the level of suspicion or indication that an individual is involved in a methamphetamine production ring. Moreover, the within invention develops indication based on the accumulation of subtle indicators or subtly suspicious acts. For instance, if John and Jack happen to purchase pseudoephedrine products at a location at instances 5 minutes apart, this could easily be explained by coincidence or happenstance. However, if this same “coincidence” happens multiple times then these events begin to go beyond the statistical probability of chance.

In this case the individual events do not carry any indication. Instead only the accumulations of similar instances have indication. If ephedrine purchase logs demonstrate three separate occasions where John and Jack purchase ephedrine-based products within 5 minutes of each other the within invention will assign a number of “Red Flags” to both John and Jack.

The within invention flag generation queries are designed to identify multi-faceted dynamics of suspicious pseudoephedrine-based product purchasing behaviors and patterns. Suspicion and/or indication levels do not always follow a clear linear or simple equation-based growth pattern. To be sure, indication related to different behaviors and/or patterns of behaviors can often follow complex non-linear growth as indication relates to the increased frequencies of suspicious behaviors or relationships between behaviors.

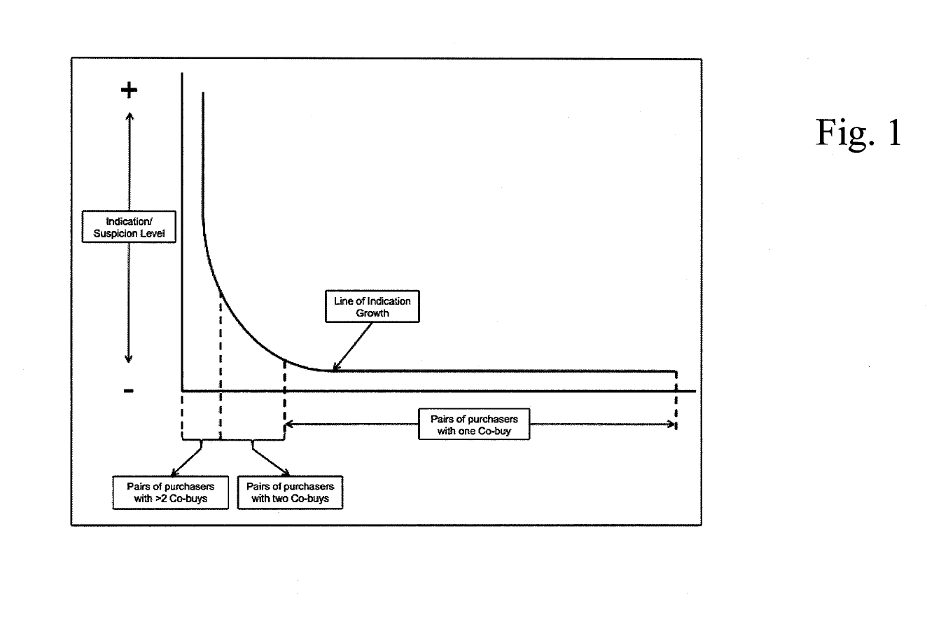

For instance, indication or suspicion levels related to instances of individuals purchasing pseudoephedrine-based products within close temporal proximity follows a curve more consistent with a power law distribution. Purchases made by two individuals within a short span of time are referred to as “Co-buys.” In a large data set (such as data for a whole state) there may be hundreds or thousands of ephedrine purchasers that can be paired with other purchasers by temporal proximity. However, only a significantly smaller number of purchasers will be paired to the same purchaser multiple times. The probability of purchasers being paired on multiple occasions by time proximity as a result of chance greatly decreases as the time period between the purchases decreases and the number of Co-buys increases. Relationships between purchases are developed in terms of strength by the number of Co-buys and the closeness in time they represent. The degree of suspicion indicated by these relationships is assigned in terms of “Red Flags” on a case-by-case basis (i.e.: three, 10 minute Co-buys=5 Red Flags) and/or by a linear equation of a curve, akin to power law distribution, where appropriate. See FIG. 1 graph illustrating this change in suspicion levels relative to Co-buys.

Other suspicious behavioral characteristics and patterns may have more simple equations and relationships to levels/degree of indication. Some Red Flags are simply defined by federal regulations associated with the Combat Methamphetamine Epidemic Act (CMEA) of 2005. For instance, the CMEA stipulates that it is illegal for any individual to purchase more than 3.6 grams of pseudoephedrine a day, and more than 9 grams of pseudoephedrine in any 30 day period. These regulations identify specific criteria for the report of suspicion and/or indictable activities. Other indication definitions are enumerated and informed by criminal behaviors that are specifically formulated to evade detection and the CMEA regulations. Pill shopper “controllers” often instruct the members of a pill shopping cell to purchase pseudoephedrine-based products only once every two weeks, and refuse to accept pills from them in any greater frequency. The dynamic generation of suspicion levels associated with the frequency of purchases by a single pill shopper again can be rule-based; cases-by-case basis; and/or based on a linear curve equation. Depending on the nature of the behavior and/or the relationship of the frequencies of that behavior to the degree of indication, flag generation queries are generated based on a variety of equations:
Logarithmic (i.e. log[˜purchases per month*# of months purchased])
Exponential (i.e. (˜purchases per month)̂ # of months purchased)
Linear (i.e. ˜purchases per month+# of months purchased)

It is important for the within invention that the Meth Hunter have a flexible structure in the flag Generation queries to cater to the specific concerns and expertise of end clients. This is due to the fact that law enforcement professionals have a good understanding of the behaviors and tendencies of criminals in their jurisdiction. The Meth Hunter's structure is flexible to adapt to fluid pill shopper environments and behaviors.

After all indicators (behaviors, patterns, relationships, etc.) are defined, it is the task of the within invention to combine these different indication/suspicion values and develop an overall suspicion level for each individual pill shopper and report it in terms of a number of Red Flags. There are a number of ways that “Red Flags” or other suspicion values are combined and used to develop an overall suspicion level.

Additive: A number of flags are assigned to each suspicious act, relationship, etc. The total number of flags for each is simply added.
High limit: The higher number of flags for any group of suspicious activities is used to represent the individual or behavior.
Kicker: Each new incident of a specific type adds 0.5, 1, or 2 flags to the existing indication level.
Average: An average of the number of flags assigned to a set of suspicious incidents is derived and assigned to the person of interest.
Multiplicative: It is possible that two suspicious events or behaviors greatly increase the suspicion level for an individual; thereby the two numbers of flags are multiplied to achieve a final suspicion level.
Subtractive: There is the potential that the Meth Hunter may identify certain characteristics of an event or behavior that should reduce the level of suspicion of an individual; thereby the value of a non-suspicious or explanative event or behavior is subtracted from the value of a suspicious one (i.e. purchases of a particular type of pseudoephedrine-based product that is particularly ill-suited for meth production, such as Primatene®).

All of these types of suspicion dynamics are or can be programmed into algorithms that fuel the within invention's suspicion/indication generating engine and customized to the behaviors and/or environment of regional pill shoppers. This component of the within invention is one of its most important facets and must be properly formulated, because it has the highest propensity to create false positives and false negatives (indicate innocent people, and fail to detect guilty ones).

Database Upload: The within invention possesses the ability to upload data from multiple pseudoephedrine purchase tracking systems with multiple entry designs or data shapes. To be sure, data points generally consist of a series of entry fields (i.e. name, date, location, etc.), different pseudoephedrine purchasing tracking systems may have differently titled, ordered, or natured fields. Coders have assessed these designs and written data parsing scripts for each of these designs to ensure that data from different tracking systems are properly mapped, aggregated, and fed into the master database that the within invention will use. The end result is a user interface that allows a user to select the type of database they wish to upload and the system will upload the data without modification. Additionally, the within invention utilizes Optical Character Recognition (OCR) technology to scan and convert paper logs to Commas Separated Value (CVS) text that is then parsed and uploaded into the database.

Analytic Processes The within invention is designed to calculate all indication values and reports on demand. The within invention saves no reports or aggregated data. This ensures that the within invention will not complicate the adherence to 28 C.F.R. 23 (federal regulation detailing the procedures for keeping criminal intelligence on any particular individual). The within invention produces reports which fall under 28 C.F.R. 23 only when a PDF report is saved or printed by law enforcement personnel. Otherwise, all aggregated data and/or reports are lost when the within invention program is closed or the user navigates away from a particular data view, and are recalculated when the program is opened again.

There are two different types of analytic processes, both driven by MySQL queries run from within PHP scripts: 1) Flag Generation (suspicion/indication generation) queries; and 2) data aggregation and display queries. Flag generation queries detect suspicious purchasing behaviors and patterns and generate an overall indication/suspicion value (in Red Flags). Data aggregation and display queries generate data views that define and elaborate why the indication/suspicion value (# of Red Flags) has been assigned to a particular purchaser.

Flag Generation Queries: Flag Generation queries search for specific behaviors and patterns in the data collected by pseudoephedrine purchase tracking systems associated with the illicit purchase of pseudoephedrine for the purposes of Meth production. These queries include:

Average Purchases Per Month/# of Months Purchased: this query develops an overall picture of a purchaser's buying behavior and assigns an indication/suspicion value (in Red Flags) respectively.

Purchase Intervals: these queries calculate indication/suspicion values based on the number of purchases a month for the number of months in the data

Temporal Purchase Proximity to other Purchasers: calculates indication/suspicion values based on the number of purchases made within a close time distance from another purchaser.

Geographic Time/Distance between Purchases made by different Purchasers: these functions query online web-based mapping API or local GIS databases to fetch geo-coordinates and driving routes with associated drive times to calculate indication/suspicion values based on the likelihood of a pill shopping route including multiple pharmacies.

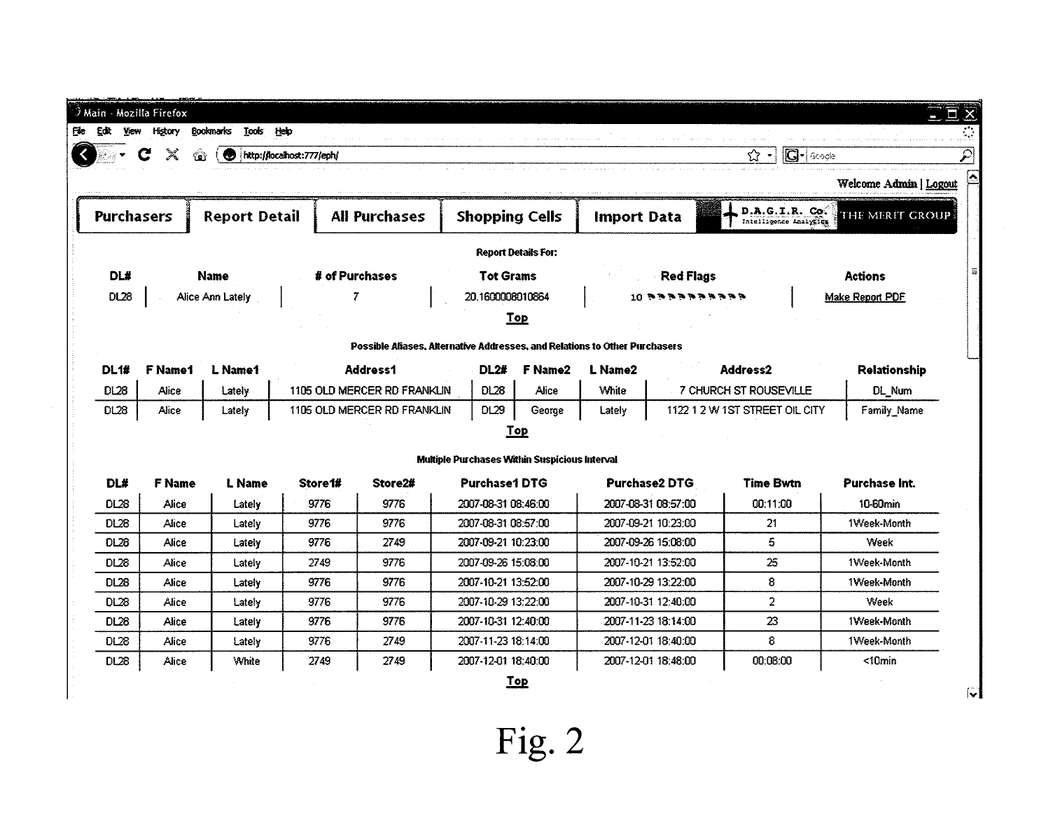

Flag generation queries consist of a series of unioned MySql queries. These queries identify, combine and calculate overall indication/suspicion values in terms of Red Flags. The end result is a display that ranks purchasers in the database in order of indication/suspicion values in terms of Red Flags. The display includes the purchaser's name, drivers license number, the number of pseudoephedrine-based purchases they have made, the overall quantity of pseudoephedrine (in grams) purchased, whether or not they have exceeded legal amounts of pseudoephedrine regulated by the CMEA and a link to an “exceedence” report (not pictured), overall number of Red Flags assigned to the individual purchaser, a link to a Report Detail view, and a link to produce a PDF report of the individual purchaser. Other functionalities include search and sort by options. See FIG. 2. which is a screenshot of the within invention showing the name, driver's license number, number of purchases, grams purchased, number of red flags and actions.

Frequency Queries (Average Purchases Per Month/# of Months Purchase): These queries categorize purchasing frequency in terms of suspicion levels. These queries (as are most of the Meth Hunter queries) are dynamic. At default, queries are set to consider any purchasing history over 2 months long; however, all variables in this query can be adjusted to fit a specific sensitivity level and/or particular behaviors consistent with pill shoppers (i.e. biweekly shopping patterns). Default Red Flag criteria can be seen in FIG. 7.
Temporal Purchase Proximity to other Purchasers: These queries are run individually with individual values according to several criteria similar to the criteria matrix set forth in FIG. 8.

Note: Due to the fact that product descriptions change for different pharmacies and brand names, the within invention contains a product description table that links same-products to a universal product description identifier.

Additionally flags are assigned by the number of co-relations characterized by temporal proximity. Therefore, on the outside of these queries, lines will stipulate how many of these relationships are necessary to produce the associated flag value.

Geographic Time/Distance between Purchases: These queries call for the drive-times between purchase locations and compare them to the time between two purchases. Again flags are assigned by the number of co-relations characterized by drive-time to purchase times comparisons. Therefore, on the outside of these queries lines will stipulate how many of these relationships are necessary to produce the associate flag value.

### Data Aggregation and Display Queries:

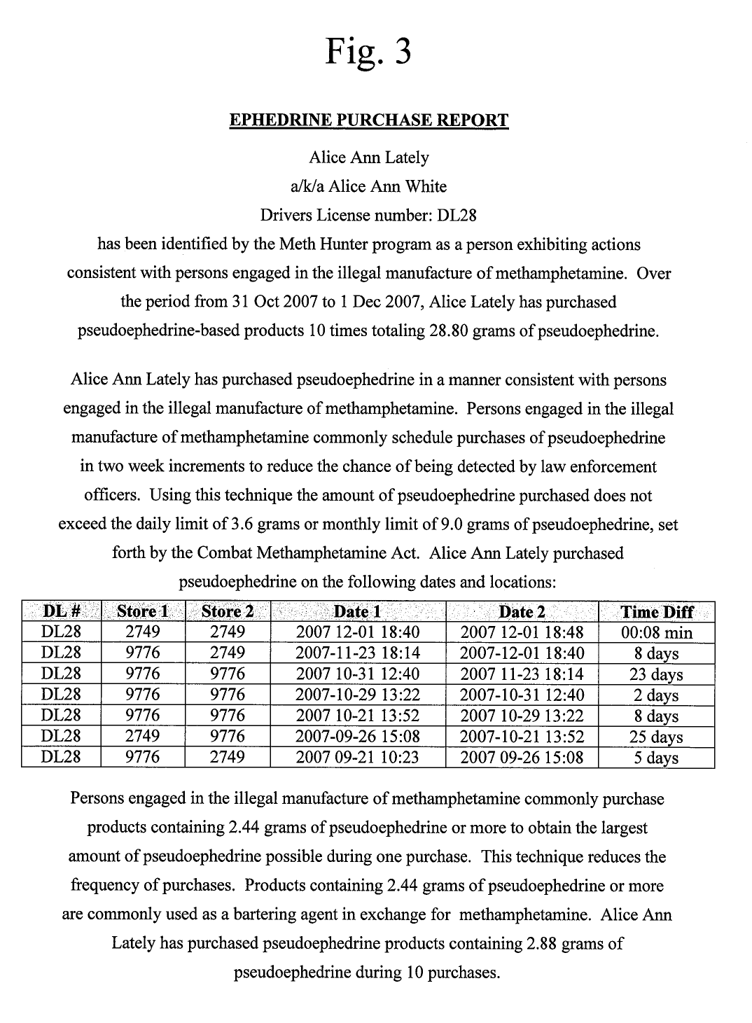

Data aggregation and display queries are similar to Flag Generation queries in the relationships and patterns they search for, but are specifically designed to display data in a manner intuitive to the user to expedite investigations. When an individual purchaser is identified by the user the Report Detail display is generated as set forth in FIG. 3. Report Detail data views include:
A summary of the purchaser including Driver's License number, name, the individual's purchase history (including number of purchases and total grams purchased), an overall indication/suspicion value (in Red Flags) (same as viewed under purchaser tab)
Possible aliases, alternative addresses, relationships to other purchasers (based on organic data points)
Purchases made by the selected purchaser in suspicious time proximity of one another
Purchases made by the selected purchaser within a suspicious time proximity to purchases made by other purchasers, and
All purchases made by the selected purchaser

### PDF Report Generation:

PDF reports are specifically designed to facilitate and be attached directly to search and arrest warrants. The within invention utilizes a PDF generator to produce reports based on PHP scripts and queries designed to generate dynamic reports that react to the information available in the database. These reports include paragraphs detailing the typical behaviors of pill shoppers and the reasons why the behaviors of the identified purchaser are suspicious. They include (paragraphs and data are only included when they are applicable to the individual in question):
Name.
Aliases.
Driver license number.
Date range of all purchases in consideration.
Number of purchases.
Total amount of pseudoephedrine purchased (in grams).
Paragraph explaining purchase restriction under the CMEA and the purchase records when the individual exceeded those limits.
Table of purchases made within a suspicious time period (preceded by a paragraph explaining the general purchasing behaviors of “pill shoppers”)
A paragraph explaining the favored amount of pseudoephedrine in products and the amount of pseudoephedrine in the pill shopper's typical purchase and the number of times that product was purchased.
A paragraph identifying the number of purchases of the same brand/type of pseudoephedrine-based products and following paragraph explaining the tendency for meth cooks to favor one particular brand/type and direct pill shoppers to purchase it.
A paragraph identifying times that the pill shopper purchased pseudoephedrine in a close temporal-proximity to other persons buying pseudoephedrine-based products and the locations of the purchases and an explanation of how pill shoppers shop in groups of 2 or more to increase the yield of pseudoephedrine purchase at a single time or location.
A table listing all purchases by the subject (pill shopper) of the report.
A table of all purchases made within a close temporal proximity to another purchaser/pill shopper.

The queries that pull data to generate the PDF report are similar to Flag Generation and Display queries and are actively fed into paragraphs detailing the nature of the suspicious information. In the PDF report, as in the Main Display, any purchase behaviors exceeding limits defined by the CMEA are identified and displayed. The within invention utilizes two query designs for identifying monthly exceedences of 9 grams of pseudoephedrine. The first query groups data by month and is a faster query. The second query groups data by any combination of purchases that exceed 9 grams and are made in under 30 days. The latter of the two queries is slower but provides a more exacting picture.

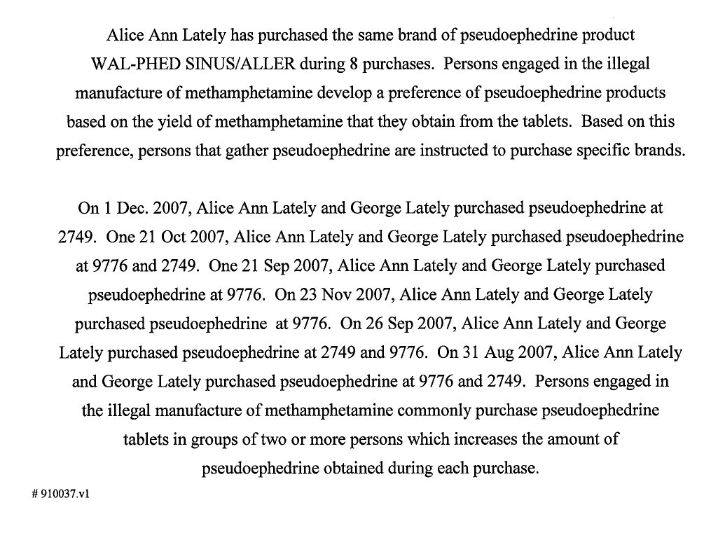

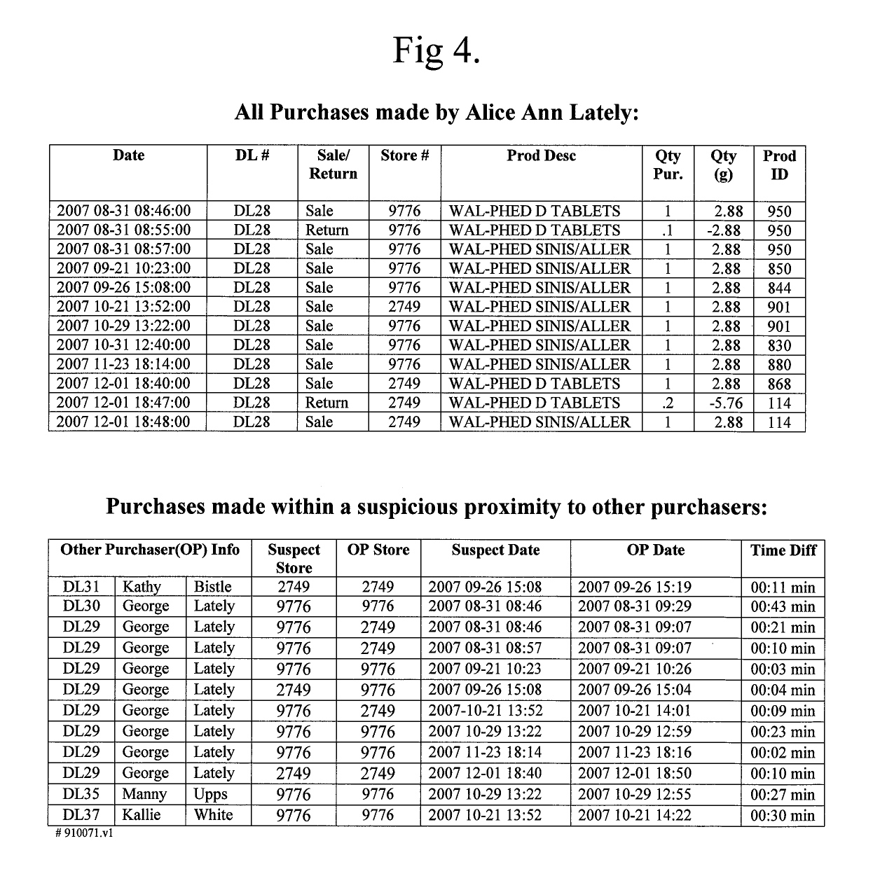

When the “Make PDF Report” link is pressed a document is generated as set forth in FIG. 4.

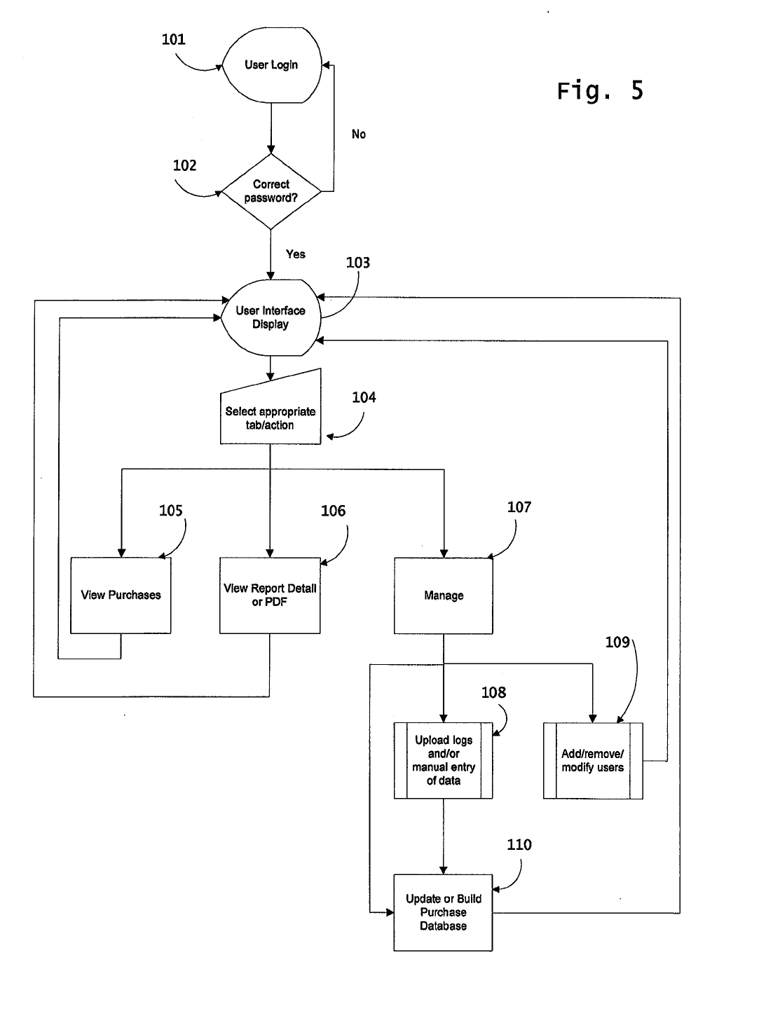

FIG. 5 represents a flowchart showing the within invention. First, the User Logs into the system at 101. If the password is correct at 102, then the user is shown the User Interface Display 103. If the password is incorrect, the user is then directed back to the User Login 101.

As represented in FIG. 5, at the User Interface Display, the user is directed to select the requested Tab or Action at 104. If the user selects View Purchases 105, the user will then be able to view all relevant purchases. If the user selects View Report Detail or PDF 106, the user will then be able to view a report of data or print out in PDF form a report as requested. If the user selects Manage 107, then the user can add, remove or modify users 109, upload data into the system 108 or directly update or build the purchase database 110. If the user wishes to upload data 108, this can be accomplished by manual entry of ephedrine purchase logs or have the computer upload the data from a file automatically. Once the data is entered, the user will then chose to Update or Build 110 the database to analyze the newly entered information. Once the user has completed the requested task (of View Purchases 105, View Report Detail or PDF 106, Update or Build Purchase Database 110 or Add/Remove/Modify Users 109) the user will be presented back to the User Interface Display 103.

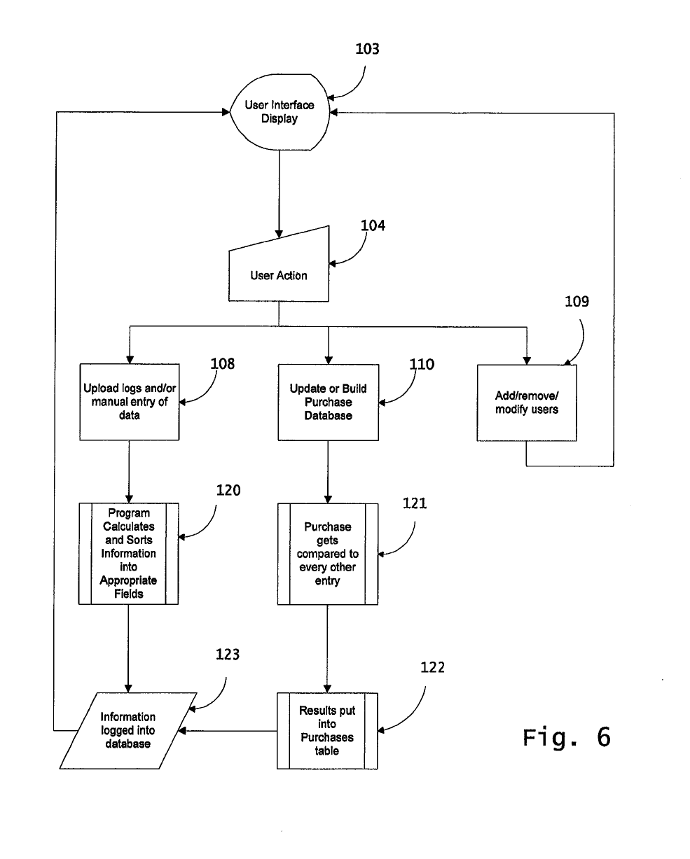

A further flowchart at FIG. 6 shows in more detail the steps taken in accomplishing each task of the within invention. At the User Interface Display 103, a User Action 104 takes place. If the user chooses to Upload logs 108, once accomplished the Program Calculates and Sorts Information into Appropriate Fields 120. Then the Information is Logged in the Database 123. If the user chooses to Update or Build Purchase Database 110, the program will automatically Compare Purchases 121 with the Results put into a Purchasers Table 122 and the Information Logged into the Database 123. Lastly, the user case simply Add/Remove or Modify Users 109. Again, after completing its task, the user is taken back to the User Interface Display 103.

We claim:

1. A method of analyzing ephedrine purchase logs, the method comprising:
a computer processor for processing data;
storage means for storing data on a storage medium;
first means for inputting data by either manual or automated means;
second means for calculating data into appropriate data fields;
third means for analyzing and filtering data for suspicious characteristics and relationships;
fourth means for logging suspicious data into a database; and,
fifth means for generating a report.

2. A method of analyzing ephedrine logs as claimed in claim 1 wherein said first means further comprises:
means for creating locations on the storage medium for storing data regarding:
(a) names of purchasers;
(b) addresses of purchasers;
(c) date of purchases;
(d) time of purchases; and,
(e) quantity of epinephrine.

3. A method of analyzing ephedrine logs as claimed in claim 2 wherein said second means further comprises:
means for calculating and storing on the storage medium the data regarding:
(a) the number of purchases made by a purchaser in a specified time period;
(b) the total quantity of ephedrine purchased within a specified time period;
(c) the geographical distance from a purchasers home to the point of sale;
(d) the time between purchasers of a single purchaser;
(e) the time between the purchases of different multiple purchasers;
(f) the geographical distance between purchase locations; and,
(g) the drive-time between purchase locations.

4. A method of analyzing ephedrine logs as claimed in claim 3 wherein said third means further comprises:
means for analyzing and filtering suspicious data and creating locations on the storage medium for storing data regarding:
(a) identified individuals of interest;
(b) identified addresses of interest;
(c) large distances between home and point of sale;
(d) the type of product purchased;
(e) amount of ephedrine in purchase;
(f) number of purchases made in a specified time period;
(g) same individuals purchasing from multiple points of sale;
(h) same individual making multiple purchases in a single day;
(i) same individual making regular patterned purchases (such as weekly or biweekly)
(j) an individuals favoritism toward a single type of ephedrine-containing product;
(k) short time periods between purchases;
(l) an individuals historic shopping pattern; and,
(m) multiple purchases made within a temporal proximity of other purchasers.

5. A method of analyzing ephedrine logs as claimed in claim 4 wherein said fourth means further comprises:
means for logging suspicious data on the storage medium for storing data regarding:
(a) assigning a number of flags to an individual depending upon:
(i) the nature of the suspicious behavior; and
(ii) the frequency of the suspicious behavior; and,
(b) permitting a user to modify the suspicious data depending on mitigating factors.

6. A method of analyzing ephedrine logs as claimed in claim 5 wherein said fifth means further comprises:
means for compiling all relevant data to present into a graphical report detailing suspicious purchase activity regarding:
(a) name of purchaser;
(b) alias of purchasers;
(c) state identification number of purchaser;
(d) date range of all purchases under consideration;
(e) total number of purchases by purchaser;
(f) total amount of ephedrine purchased by purchaser;
(g) a table of purchases made within a suspicious time period; and,
(h) identification of purchases made by other individuals in close proximity and/or time.
